(19) United States
(12) Patent Application Publication
(10) Pub. No.: US 2020/0026596 A1
(43) Pub. Date: Jan. 23, 2020

(54) I/O RECOVERY AND DIAGNOSTICS

(71) Applicant: International Business Machines Corporation, Armonk, NY (US)

(72) Inventors: David C. Reed, Tucson, AZ (US); Joseph V. Malinowski, Oak Forest, IL (US); Eric Seftel, New York, NY (US); Tabor R. Powelson, Poughkeepsie, NY (US)

(73) Assignee: International Business Machines Corporation, Armonk, NY (US)

(21) Appl. No.: 16/041,776

(22) Filed: Jul. 21, 2018

(51) Int. Cl. G06F 11/07; G06F 11/34

(52) U.S. Cl. CPC G06F 11/0793; G06F 11/0757; G06F 11/3485; G06F 11/0772; G06F 11/3419; G06F 11/0745

(57) ABSTRACT

A method for monitoring I/O is disclosed. In one embodiment, such a method includes identifying various stages of an I/O process. The method further monitors progress of an I/O operation as it advances through the stages of the I/O process. The method records, in a data structure associated with the I/O operation, timing information indicating time spent in each of the stages. This timing information may include, for example, entry and exit times of the I/O operation relative to each of the stages. In the event the I/O operation exceeds a maximum allowable time spent in one or more of the stages, the method generates an error. Various recovery actions may be taken in response to the error. A corresponding system and computer program product are also disclosed.

### BACKGROUND

### Field of the Invention

This invention relates to systems and methods for monitoring and tuning input/output (I/O) operations.

### Background of the Invention

In today's digital economy, application performance and availability are increasingly important. As more and more commerce and social interaction moves online, applications are expected to provide high performance and be available around the clock with few if any interruptions. However, managing application performance and availability is often difficult. This is because there are a significant number of components and stages between application users and storage devices that store data. Each of these components and stages must operate efficiently to maintain high performance and availability. Any bottlenecks through these components and/or stages can degrade the user experience and/or undermine business effectiveness. Although the performance of physical components can be important, the ability to monitor and manage the flow of I/O through the operating system can be just as important to ensure overall application performance and availability.

In current systems, when an I/O does not complete it can result in system hangs and application outages. These events can be extremely costly and have significant impacts if they take place with a critical application. As discussed above, as an I/O progresses from start to finish it may proceed through various stages. It is often impossible to determine in which stage an I/O encounters a problem or experiences a bottleneck. Issues may occur at different points in the process. Regardless of the stage where an I/O problem or bottleneck occurs, there is often no detection mechanism to determine that an error event has occurred other than the external symptom of an application hang or poor performance. Thus, it can be difficult to determine a proper recovery action, which may be different depending on how far the I/O has progressed through the system.

In view of the foregoing, what are needed are systems and methods to more efficiently monitor and manage the flow of I/O through a system. Ideally, such systems and methods will be able to pinpoint where problems or bottlenecks occur in the system. Further needed are systems and methods to dynamically tune the system to reduce and/or eliminate the problems and/or bottlenecks.

### SUMMARY

The invention has been developed in response to the present state of the art and, in particular, in response to the problems and needs in the art that have not yet been fully solved by currently available systems and methods. Accordingly, systems and methods have been developed to more efficiently monitor I/O and tune I/O performance. The features and advantages of the invention will become more fully apparent from the following description and appended claims, or may be learned by practice of the invention as set forth hereinafter.

Consistent with the foregoing, a method for monitoring I/O is disclosed. In one embodiment, such a method includes identifying various stages of an I/O process. The method further monitors progress of an I/O operation as it advances through the stages of the I/O process. The method records, in a data structure associated with the I/O operation, timing information indicating time spent in each of the stages. This timing information may include, for example, entry and exit times of the I/O operation relative to each of the stages. In the event the I/O operation exceeds a maximum allowable time spent in one or more of the stages, the method generates an error. Various recovery actions may be taken in response to the error. A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a network environment in which systems and methods in accordance with the invention may be implemented;

FIG. 2 is a high-level block diagram showing one example of a storage system in the network environment of FIG. 1;

FIG. 3 is a high-level block diagram showing various data structures and modules that may be used to monitor and manage I/O performance;

FIG. 4 is a high-level block diagram showing an example of stages of an I/O process;

FIG. 5 is a high-level block diagram showing an I/O performance management module and associated sub-modules;

FIG. 6 shows various recovery actions that may be taken in response to different errors; and

FIG. 7 shows various tuning actions that may be taken in response to various thresholds being crossed.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

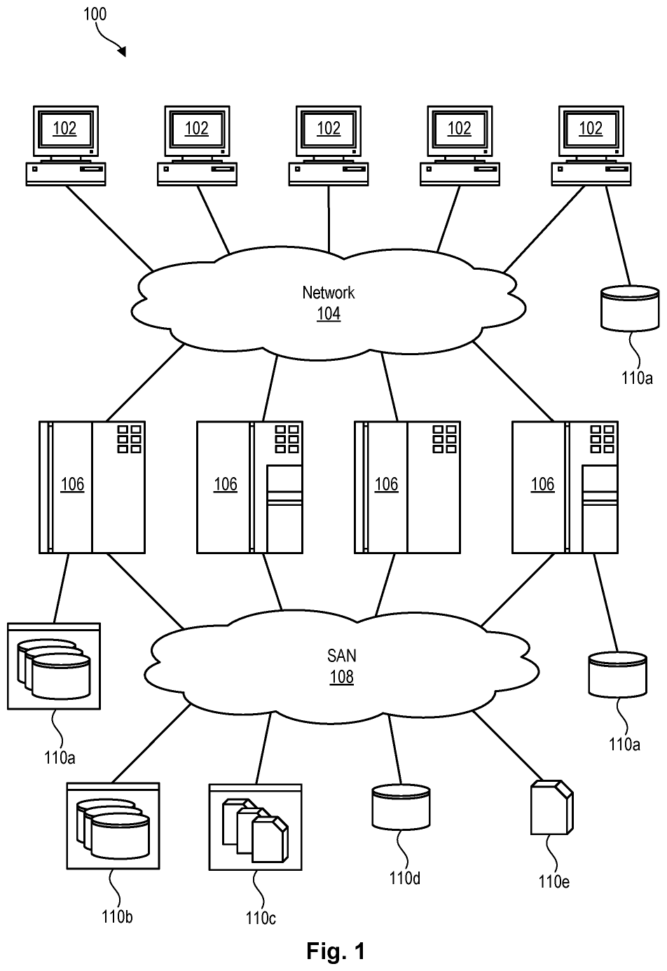

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of different network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 110a (e.g., arrays of hard-disk drives, solid-state drives, tape drives, etc.). These computers 102, 106 and direct-attached storage systems 110a may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems, such as arrays 110b of hard-disk drives or solid-state drives, tape libraries 110c, individual hard-disk drives 110d or solid-state drives 110d, tape drives 110e, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

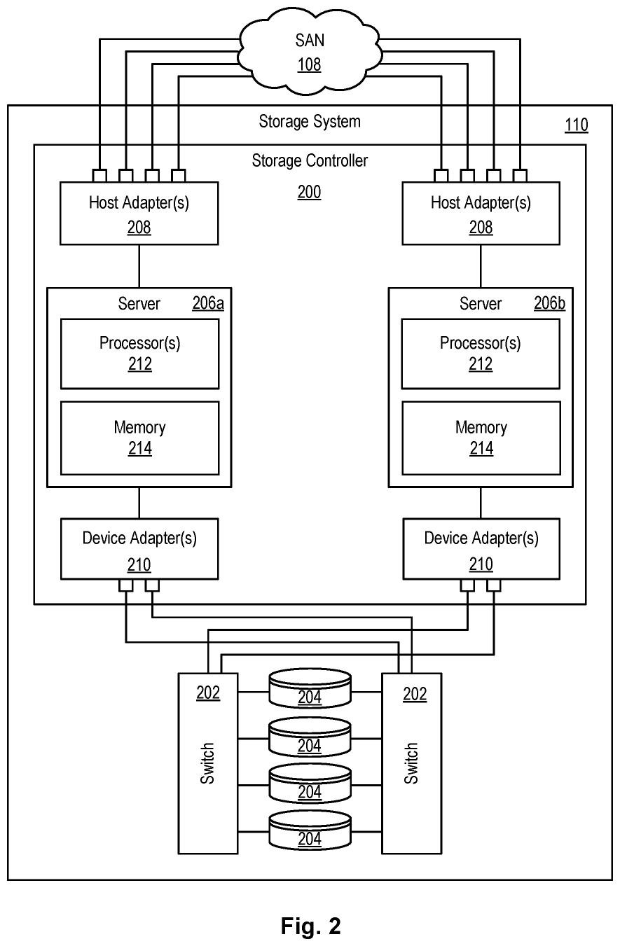

Referring to FIG. 2, one embodiment of a storage system 110 containing an array of hard-disk drives 204 and/or solid-state drives 204 is illustrated. As shown, the storage system 110 includes a storage controller 200, one or more switches 202, and one or more storage drives 204, such as hard disk drives 204 or solid-state drives 204 (such as flash-memory-based drives 204). The storage controller 200 may enable one or more hosts 106 (e.g., open system and/or mainframe servers 106 running operating systems such z/OS, zVM, or the like) to access data in the one or more storage drives 204.

In selected embodiments, the storage controller 200 includes one or more servers 206. The storage controller 200 may also include host adapters 208 and device adapters 210 to connect the storage controller 200 to host devices 106 and storage drives 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

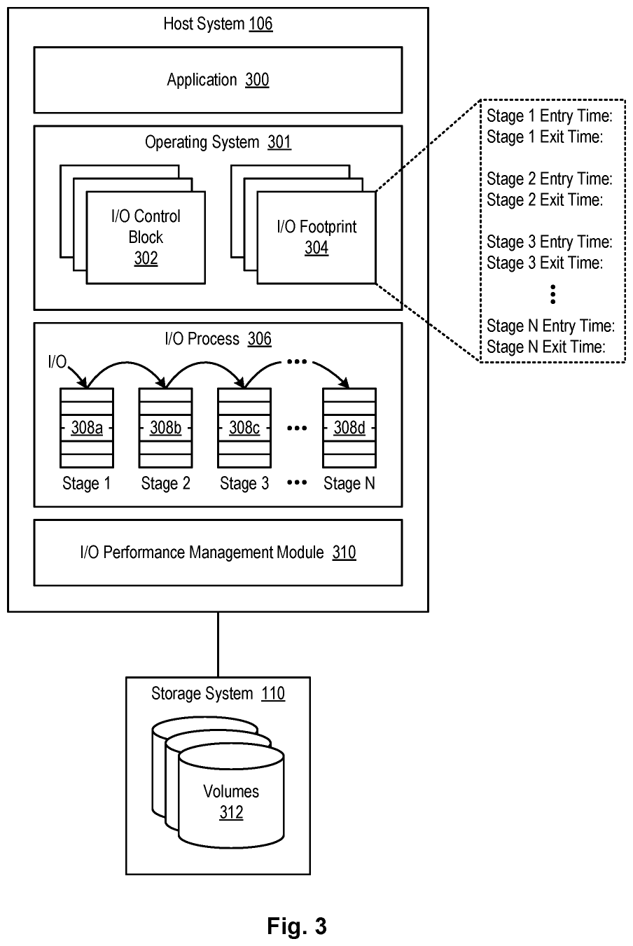

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage drives 204. These software modules may manage all read and write requests to logical volumes 312 (See FIG. 3) in the storage drives 204.

One example of a storage system 110 having an architecture similar to that illustrated in FIG. 2 is the IBM DS8000™ enterprise storage system. The DS8000™ is a high-performance, high-capacity storage controller providing disk storage that is designed to support continuous operations. Nevertheless, the systems and methods disclosed herein are not limited to operation with the IBM DS8000™ enterprise storage system 110, but may operate with any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented by way of example and is not intended to be limiting.

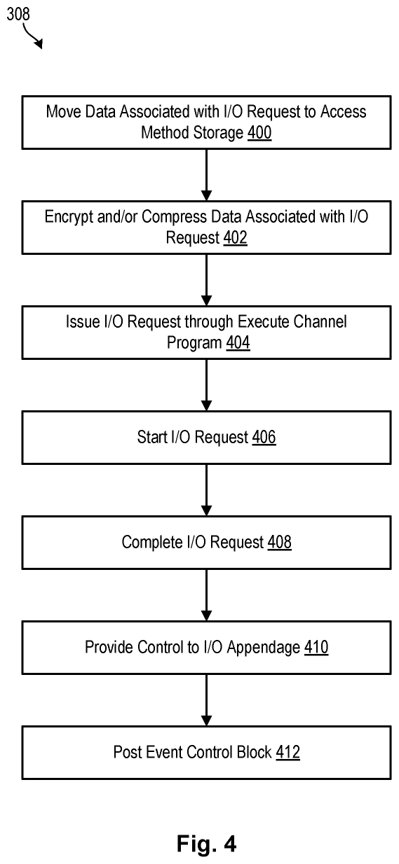

Referring to FIG. 3, as previously mentioned, when I/O from a host system 106 to a storage system 110 does not complete, it may result in system hangs and application outages. These events can be extremely costly and have significant impacts if they take place with a critical application 300. As an I/O progresses from start to finish it may proceed through various stages 308. As shown in FIG. 4, these stages 308 may include, for example, (1) moving 400 data associated with an I/O operation to access method storage, (2) encrypting 402 and/or compressing 402 data associated with the I/O operation, (3) issuing 404 the I/O operation through a call to an I/O driver such as execute channel program, (4) starting 406 of the I/O operation, (5) completing 408 of the I/O operation, (6) providing 410 control to an I/O appendage, and (7) posting 412 of an event control block.

It is often impossible to determine in which of these stages 308 the I/O encountered a problem or experienced a bottleneck. Issues may occur at different stages 308 in the I/O process 306. Regardless of the stage 308 where an I/O problem or bottleneck occurs, in conventional systems, there is often no detection mechanism to determine whether an error event has occurred other than external symptom of an application hang or poor performance. Thus, it can be difficult to determine a proper recovery action, which may be different depending on how far the I/O has progressed through the system.

In order to more efficiently monitor and manage the flow of I/O through a system, an I/O performance management module 310 may be provided. In the illustrated embodiment, this I/O performance management module 310 is provided in the host system 106. This I/O performance management module 310 may be configured to pinpoint where I/O performance problems or bottlenecks are occurring in the system. The I/O performance management module 310 also may, in certain embodiments, be configured to dynamically tune the system to reduce and/or eliminate the problems and/or bottlenecks.

In certain embodiments, the I/O performance management module 310 may utilize an I/O footprint 304 that stores timing information for an I/O operation in each stage 308 of an I/O process 306. This timing information may include, for example, entry and/or exit times of an I/O operation in each stage 308 of the I/O process 306. In certain embodiments, the I/O footprint 304 is associated with an I/O control block 302 that uniquely represents an I/O operation to an operating system 301.

As an I/O operation progresses through each stage 308 of an I/O process 306, it is placed on a stack associated with the stage 308 and the I/O performance management module 310 updates the I/O footprint 304 to reflect the time that it is added to the stack. Items on a stack are typically processed in ascending timestamp order. As I/O operations on a stack are processed, the I/O performance management module 310 determines if an I/O operation's time on the stack exceeds a threshold. If so, the I/O performance management module 310 may generate an error and take steps to recover from the error. These recovery steps may include, for example, restarting the I/O operation, posting an event control block (ECB) as either good or bad, and/or terminating a job or task associated with the I/O operation.

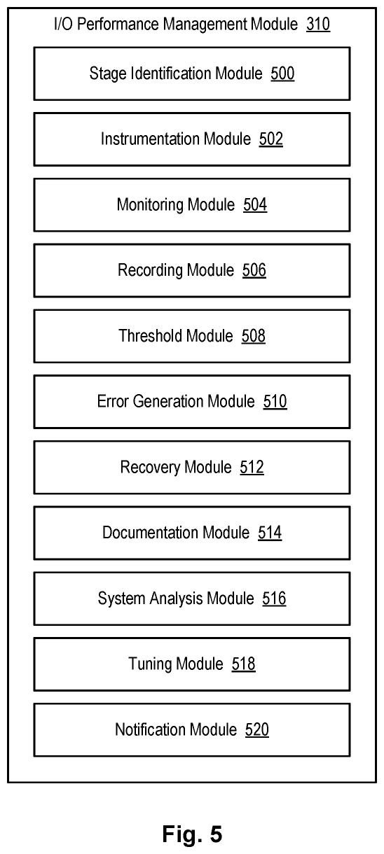

Referring to FIG. 5, a high-level block diagram showing an I/O performance management module 310 and associated sub-modules is illustrated. The I/O performance management module 310 and associated sub-modules may be implemented in hardware, software, firmware, or combinations thereof. The I/O performance management module 310 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, the I/O performance management module 310 may include one or more of a stage identification module 500, instrumentation module 502, monitoring module 504, recording module 506, threshold module 508, error generation module 510, recovery module 512, documentation module 514, system analysis module 516, tuning module 518, and notification module 520.

As shown, the stage identification module 500 may be configured to identify stages 308 in an I/O process 306. This may include breaking down the I/O process 306 into more granular steps or phases that occur when processing an I/O operation. The instrumentation module 502 may instrument these steps or phases so that timing information is generated when an I/O operation enters, exits, and/or performs other actions within these steps or phases. The monitoring module 504 then monitors an I/O operation as it proceeds through the I/O process 306. As the I/O operation proceeds from stage 308 to stage 308, the recording module 506 records timing information in the I/O footprint 304 previously discussed. This may include recording enters and/or exits of the I/O operation from each of the stages 308.

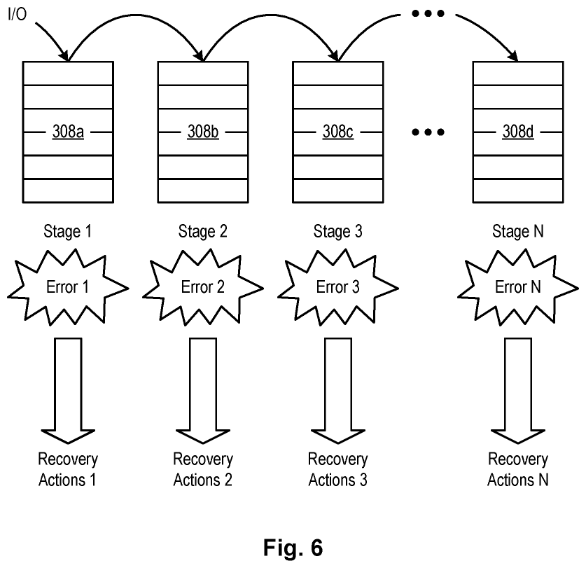

The threshold module 508 may be configured to determine whether time spent in a particular stage 308 of the I/O process 306 crosses a threshold. If so, the error generation module 510 may generate an error and the recovery module 512 may initiate a recovery process. As shown in FIG. 6, the error and/or recovery process may be different depending on which stage 308 of the I/O process 306 the threshold was crossed. A different threshold may be established for each stage 308 of the I/O process 306, depending on what is deemed to be an acceptable amount of time for an I/O operation to be in the particular stage 308. These thresholds may be set on an application- or system-wide level. In certain embodiments, lower thresholds (i.e., lower acceptable times) may be set for more critical applications 300. When an error is generated, the documentation module 514 may document the error and conditions associated with the error. For example, the documentation module 514 may initiate and collect diagnostic dump information, perform state saves, take snapshots of system logs, collect system traces, or the like when an error is generated by the error generation module 510. The type of documentation collected may differ for each stage 308 of the I/O process 306.

When a threshold is crossed and/or an error is generated, the system analysis module 516 may analyze the system to determine what computing resources, or lack thereof, caused the threshold to be crossed. For example, a shortage of memory, buffers, storage, processor time, communication paths, network connections, or the like, may have caused the I/O operation to exceed a time threshold within a particular stage 308. In certain embodiments, each stage 308 has specific computing resource deficiencies that cause a threshold to be crossed within the particular stage 308.

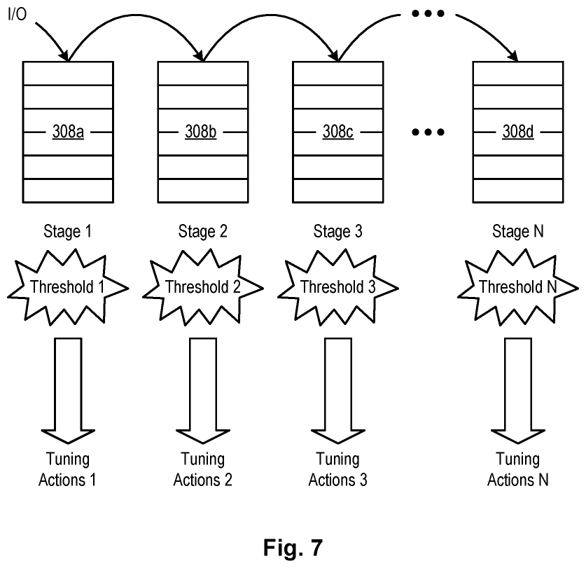

The tuning module 518 may be configured to automatically and dynamically adjust an allocation of computing resources in the event an I/O operation exceeds a maximum allowable time (i.e., exceeds the time threshold) in a stage 308 of the I/O process 306. This may be performed to reduce or eliminate the bottleneck that caused the threshold to be crossed. As shown in FIG. 7, different tuning actions may be performed based on the stage 308 where the threshold was crossed. The tuning module 518 may perform actions such as add extra storage, adjust a number of buffers available to an application, add extra physical resources to a system, add extra logical resources to a system, increase a service class associated with I/O operations, increase a dispatch priority associated with I/O operations, take a communication path offline or bring a communication path online, invoke a Hyperswap operation, modify a storage tier used to service I/O operations, suspend mirroring of data, or the like. Whenever a tuning action is performed, an error is detected, or the like, the notification module 520 may be configured to notify a user or administrator. The notification module 520 may also, in certain embodiments, direct status and messages to a system monitoring program.

As previously mentioned, in certain embodiments, stages 308 of the I/O process 306 may include (1) moving 400 data associated with the I/O operation to access method storage, (2) encrypting 402 and/or compressing 402 data associated with the I/O operation, (3) issuing 404 the I/O operation through a call to an I/O driver such as execute channel program, (4) starting 406 of the I/O operation, (4a) re-driving the I/O operation if necessary, (5) completing 408 of the I/O operation, (6) providing 410 control to an I/O appendage (an appendage is a routine that provides additional control over I/O operations) and (7) posting 412 of an event control block.

In certain embodiments, the I/O performance management module 310 may be configured to take specific actions when thresholds are crossed for the stages 308 identified above. For example, the I/O performance management module 310 may terminate a task and collect diagnostic dump information when there is a problem with control blocks related to I/O construction (stage 3 above), an I/O operation has been retried too many times (stage 5 above), a permanent error has occurred such as a severe alert sense data (stage 5 above), or when an event control block has been posted but a task still does not complete (stage 7 above).

The I/O performance management module 310 may retry an I/O operation when the I/O was issued but did not complete (stage 4 above). If the I/O still does not complete, a channel log may be created and a state save may be requested if such an option is enabled. The I/O performance management module 310 may trigger a non-disruptive state save (NDSS) for the storage controller 200 and request a channel log when I/O completion time between stages 4 and 5 exceeds a specified time limit. The NDSS may be triggered by issuing a command to force the NDSS. The channel log may be initiated by issuing a channel subsystem call to initiate logging.

The event control block may be posted in cases where it is missing after channel end status and device end have been confirmed after stage 5 above. This may protect against logic errors in I/O appendages that prevent the event control block from being posted. A logrec entry may be taken if the time threshold is crossed between stages 5 and 6 above by noting the time the I/O appendage was called.

The I/O performance management module 310 may also be configured to dynamically tune the system to correct bottlenecks or undesired delays in the I/O process 306. For any stage in the I/O process 306, if an I/O delay is detected, the I/O performance management module 310 may examine the overall system processor utilization and request additional physical or logical resources for the partition. For other specific stages 308, the I/O performance management module 310 may be configured to take specific actions. For example, for stage 1 above, if aggregate time spent moving user data to access method buffers, or the number of times the data is moved, exceeds a specified target, the I/O performance management module 310 may allocate additional storage to increase the number or size of the buffers. For stage 2 above, if compression or encryption is delayed, the I/O performance management module 310 may assign additional resources or appliances to provide compression or encryption functions. For stage 3 above, if I/O is delayed while executing the channel program, the I/O performance management module 310 may increase a service class or dispatching priority to improve I/O throughput.

For stages 4 and 4a above, if excessive re-drives are detected, it may be due to logical or physical errors in the I/O subsystem. In such cases, the I/O performance management module 310 may take a path offline or alert service personnel. Alternatively, or additionally, the I/O performance management module 310 may invoke a Hyperswap if such an option is enabled. For stage 5 above, if the delay is related to I/O completing on the storage system 110, and the storage system 110 has multiple tiers of storage, the I/O performance management module 310 may initiate I/O operations on a higher performance storage tier. If the delay is due to synchronous mirroring, the I/O performance management module 310 may, in certain cases, suspend mirroring to improve I/O performance. For stages 6 and 7 above, if delays are associated with executing a service request block (SRB), the I/O performance management module 310 may take steps to improve asynchronous I/O completion performance where possible.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for monitoring I/O, the method comprising:
identifying a plurality of stages of an I/O process;
monitoring progress of an I/O operation as it advances through the stages of the I/O process;
recording, in a data structure associated with the I/O operation, timing information indicating time spent in each stage of the plurality of stages; and
generating an error in the event the I/O operation exceeds a maximum allowable time spent in at least one stage of the plurality of stages.

2. The method of claim 1, wherein the timing information includes an entry time of the I/O operation into at least one stage of the plurality of stages.

3. The method of claim 1, wherein the timing information includes an exit time of the I/O operation from at least one stage of the plurality of stages.

4. The method of claim 1, wherein the data structure is associated with a control block that uniquely represents the I/O operation to an operating system.

5. The method of claim 1, wherein the stages include at least one of: (1) moving data associated with the I/O operation to access method storage, (2) encrypting and/or compressing data associated with the I/O operation, (3) issuing the I/O operation through a call to an I/O driver such as execute channel program, (4) starting of the I/O operation, (5) completing of the I/O operation, (6) providing control to an I/O appendage, and (7) posting of an event control block.

6. The method of claim 1, further comprising, in the event an error is generated, retrying the I/O operation.

7. The method of claim 1, further comprising, in the event an error is generated, terminating the I/O operation.

8. A computer program product for monitoring I/O, the computer program product comprising a non-transitory computer-readable storage medium having computer-usable program code embodied therein, the computer-usable program code configured to perform the following when executed by at least one processor:
identify a plurality of stages of an I/O process;
monitor progress of an I/O operation as it advances through the stages of the I/O process;
record, in a data structure associated with the I/O operation, timing information indicating time spent in each stage of the plurality of stages; and
generate an error in the event the I/O operation exceeds a maximum allowable time spent in at least one stage of the plurality of stages.

9. The computer program product of claim 8, wherein the timing information includes an entry time of the I/O operation into at least one stage of the plurality of stages.

10. The computer program product of claim 8, wherein the timing information includes an exit time of the I/O operation from at least one stage of the plurality of stages.

11. The computer program product of claim 8, wherein the data structure is associated with a control block that uniquely represents the I/O operation to an operating system.

12. The computer program product of claim 8, wherein the stages include at least one of: (1) moving data associated with the I/O operation to access method storage, (2) encrypting and/or compressing data associated with the I/O operation, (3) issuing the I/O operation through a call to an I/O driver such as execute channel program, (4) starting of the I/O operation, (5) completing of the I/O operation, (6) providing control to an I/O appendage, and (7) posting of an event control block.

13. The computer program product of claim 8, wherein the computer-usable program code is further configured to, in the event an error is generated, retry the I/O operation.

14. The computer program product of claim 8, wherein the computer-usable program code is further configured to, in the event an error is generated, terminate the I/O operation.

15. A system for monitoring I/O, the system comprising:
at least one processor;
at least one memory device operably coupled to the at least one processor and storing instructions for execution on the at least one processor, the instructions causing the at least one processor to:
identify a plurality of stages of an I/O process;
monitor progress of an I/O operation as it advances through the stages of the I/O process;
record, in a data structure associated with the I/O operation, timing information indicating time spent in each stage of the plurality of stages; and
generate an error in the event the I/O operation exceeds a maximum allowable time spent in at least one stage of the plurality of stages.

16. The system of claim 15, wherein the timing information includes an entry time of the I/O operation into at least one stage of the plurality of stages.

17. The system of claim 15, wherein the timing information includes an exit time of the I/O operation from at least one stage of the plurality of stages.

18. The system of claim 15, wherein the data structure is associated with a control block that uniquely represents the I/O operation to an operating system.

19. The system of claim 15, wherein the stages include at least one of: (1) moving data associated with the I/O operation to access method storage, (2) encrypting and/or compressing data associated with the I/O operation, (3) issuing the I/O operation through a call to an I/O driver such as execute channel program, (4) starting of the I/O operation, (5) completing of the I/O operation, (6) providing control to an I/O appendage, and (7) posting of an event control block.

20. The system of claim 15, wherein the instructions further cause the at least one processor to, in the event an error is generated, at least one of retry and terminate the I/O operation.
